(19) United States
(12) Patent Application Publication
(10) Pub. No.: US 2013/0166447 A1
(43) Pub. Date: Jun. 27, 2013

(54) GATEWAY APPLICATIONS FOR TRANSACTION SERVICES

(71) Applicants: Brian P. Theado, Canal Winchester, OH (US); Khoa N. Nguyen, Westerville, OH (US); Lloyd S. Palmer, JR., Hilliard, OH (US)

(72) Inventors: Brian P. Theado, Canal Winchester, OH (US); Khoa N. Nguyen, Westerville, OH (US); Lloyd S. Palmer, JR., Hilliard, OH (US)

(73) Assignee: VERIZON PATENT AND LICENSING INC., Basking Ridge, NJ (US)

(21) Appl. No.: 13/332,748

(22) Filed: Dec. 21, 2011

(51) Int. Cl. G06Q 20/40; G06F 15/16

(52) U.S. Cl. 705/44; 709/217

(57) ABSTRACT

A method may include receiving a first message from a transaction device via an intermediate component, the first message requesting an authorization or a settlement of a transaction. The method may also include emulating a customer host device based on a first portion of the first message, generating a second message via the emulation, and routing the second message via a persistent socket that forms a communication link with the customer host device. The second message may request a component on the customer host device to authorize the transaction or to settle the transaction.

### BACKGROUND

Transaction services may generally include data communications over a network to support a secure transaction. Transaction services may be characterized by short sessions to support inquiry-and-response applications. Transaction applications may include, for example, credit/debit card authorization, automated teller machine (ATM) activity, insurance verification, and home health monitoring. Customers of transaction services may include payment processing entities.

### BRIEF DESCRIPTION OF THE DRAWINGS

FIG. 1 is a diagram that illustrates an exemplary network in which systems and/or methods, described herein, may be implemented;

FIG. 2 is a diagram that illustrates additional details of a portion of the network of FIG. 1;

FIG. 3 is a diagram that illustrates components of the transaction services hub of FIG. 2;

FIG. 4 is a diagram that illustrates an exemplary network arrangement for a portion of the transaction network of FIG. 1;

FIG. 5 is a diagram of exemplary components of a device that may be used within the network of FIGS. 1-4;

FIG. 6 is a diagram of exemplary components of the transaction services data system of FIG. 3 and a portion of network of FIG. 2;

FIG. 7A and FIG. 7B are diagrams illustrating flows of messages between the transaction device of FIGS. 1 and 2, the customer host of FIG. 6, and components of the transaction services data system of FIG. 6 when the transaction device requests an authorization from the customer host;

FIG. 8 is a diagram illustrating flows of messages between the transaction device of FIGS. 1 and 2, the customer host of FIG. 6, and components of the transaction services data system of FIG. 6 when the transaction device performs a settlement with the customer host;

FIG. 9 is a diagram illustrating flows of data through different components of the transaction gateway application, the host gateway application, and the customer host of FIG. 6;

FIG. 10 is a block diagram of exemplary functional components of the transaction gateway application of FIG. 6;

FIG. 11 is a block diagram of exemplary functional components of the host gateway application of FIG. 6;

FIG. 12 is a flow diagram of an exemplary process that is associated with flows of data from the transaction device of FIG. 6 to the customer host of FIG. 6, through the transaction gateway application and the host gateway application of FIG. 6.

FIG. 13 is a flow diagram of another exemplary process that is associated with flows of data from the customer host of FIG. 6 to the transaction device of FIG. 6, through the transaction gateway application and the host gateway application of FIG. 6; and

FIG. 14 is a diagram illustrating exemplary flows of data via different components and methods associated with the transaction gateway application and the host gateway application of FIG. 6.

### DETAILED DESCRIPTION OF PREFERRED EMBODIMENTS

The following detailed description refers to the accompanying drawings. The same reference numbers in different drawings may identify the same or similar elements.

Transaction services may be provided to entities that need a network solution for short (e.g., typically less than 15 seconds) connections for their customers (e.g., merchants) to reach their hosts. A majority of traffic in transaction services can arise from credit or debit card transactions; but other types of traffic may also utilize these services, including insurance verification, home health monitoring, processing of fishing and hunting licenses, etc. Transaction services customers are typically referred to as “processors” or “hosts” that act as middle men between, for example, merchants on one end and banks or card marketing organizations (e.g., Visa®, Mastercard®, etc.) on the other end.

As described herein, a transaction gateway application and a host gateway application, collectively referred to as “gateway applications,” are part of a transaction services data system. The transaction services data system may relay messages from/to transaction devices to/from transaction services customers and provide support functions that are related to relaying the messages. Within the transaction services data system, the gateway applications identify destinations for received messages, select or set up sessions for efficient delivery of messages, and format and forward messages. In addition, the gateway applications may log their activities for reporting purposes and/or for allowing operators/administrators to resolve problems.

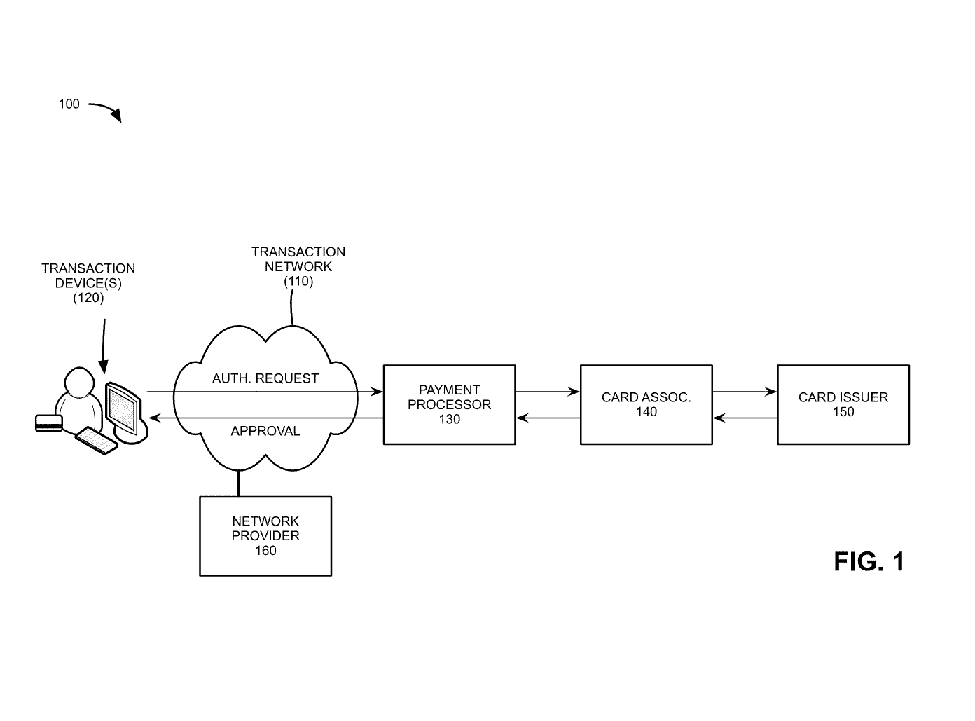

FIG. 1 is a diagram that illustrates an exemplary network 100 in which systems and/or methods described herein may be implemented. As shown in FIG. 1, network 100 may include a transaction network 110, a transaction device 120, a payment processor 130, a card association 140, a card issuer 150, and a network provider 160. Devices and/or networks of FIG. 1 may be connected via wired and/or wireless connections.

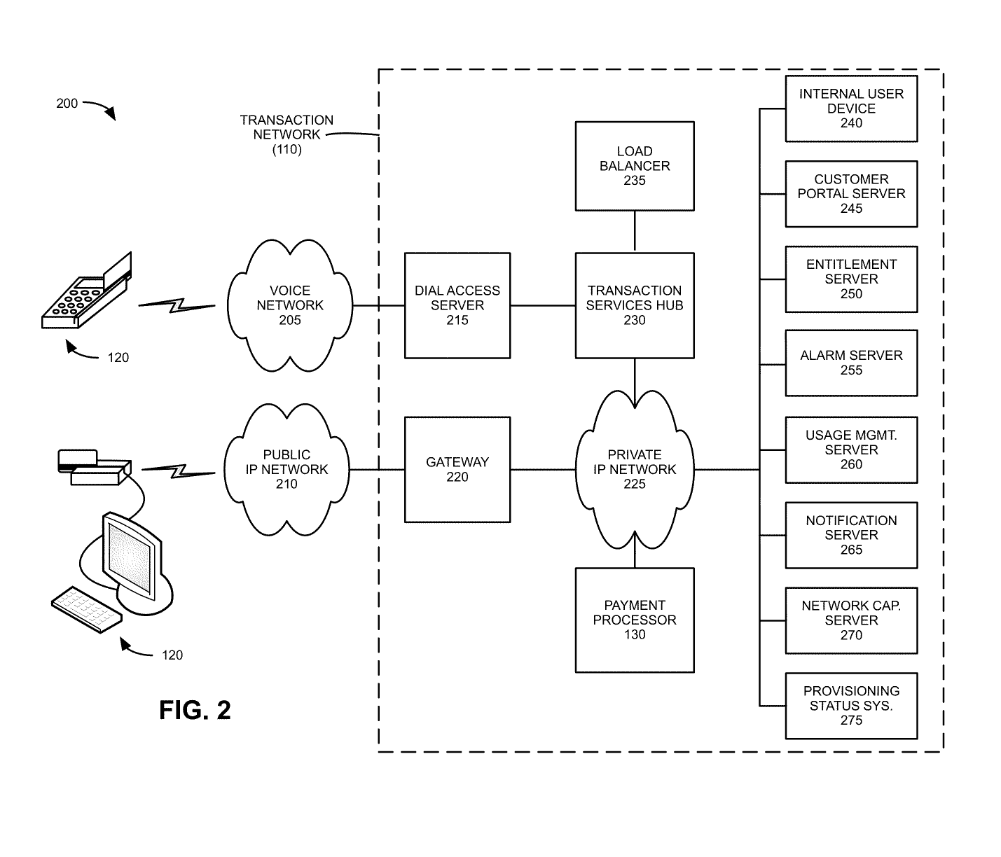

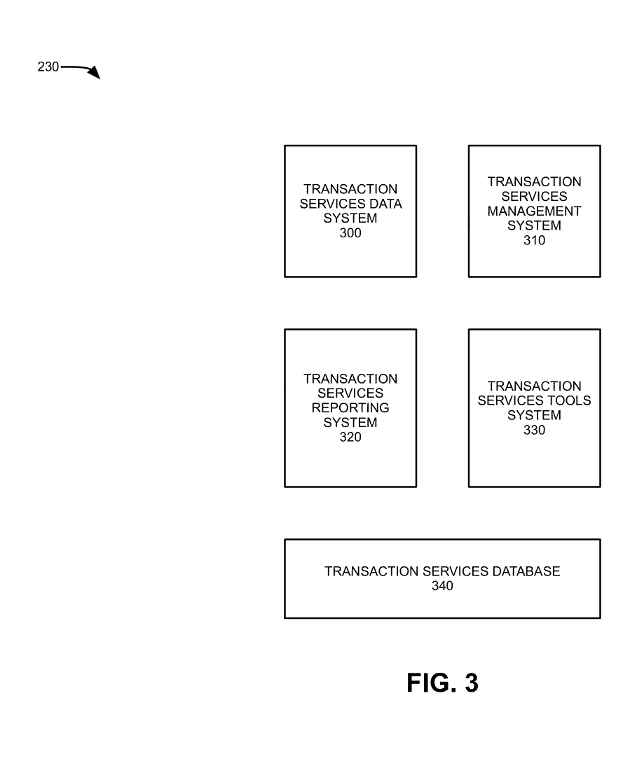

Transaction network 110 may facilitate data communications, such as credit card authorizations, between transaction device 120 and payment processor 130. Particularly, transaction network 110 may facilitate transactions characterized by short sessions, low bandwidth requirements, and quick call set-ups, for inquiry-response applications. Transaction network 110 may generally include one or more wired, wireless, and/or optical networks that are capable of receiving and transmitting data, voice and/or video signals. For example, transaction network 110 may include one or more public switched telephone networks (PSTNs) or another type of switched network. Transaction network 110 may also include one or more wireless networks and may include a number of transmission towers for receiving wireless signals and forwarding the wireless signals toward the intended destination. Transaction network 110 may further include one or more satellite networks, one or more packet switched networks, such as an Internet protocol (IP) based network, a local area network (LAN), a wide area network (WAN), a personal area network (PAN), a WiFi network, a Bluetooth network, an intranet, the Internet, or another type of network that is capable of transmitting data. In some implementations, transaction network 110 may include a private network controlled by, for example, a telecommunications company (e.g., network provider 160) that provides telephone and/or data access to transaction device 120. In another implementation, transaction network 110 may include a public network, such as the Internet, or a combination of public and private networks. Transaction network 110 is described further in connection with, for example, FIGS. 2 and 3.

Transaction device(s) 120 may participate in a transaction, such as a purchase of goods or services from a merchant or other entity associated with transaction device 120. Transaction device 120, for example, may include an electronic cash register or point-of-sale system at a retail location or another device/system that is able to receive payment information and/or other information from a user and/or a payment card (e.g., credit card, identity card, etc.). Additionally, or alternatively, transaction device 120 may include a personal computer, a laptop computer, a tablet or “pad” computer, a personal communications system (PCS) terminal (e.g., that may combine a cellular radiotelephone with data processing and data communications capabilities), a personal digital assistant (PDA, e.g., that can include a radiotelephone, a pager, Internet/intranet access, etc.), a smartphone, or other types of computation and/or communication devices. In one implementation, transaction device 120 may include any device (e.g., an IP-based device) that enables a user to access the Internet and/or communicate with other devices. In one implementation, transaction device 120 may communicate with payment processor 130 via transaction network 110 when a transaction (e.g., a credit card purchase, point-of-sale transaction, etc.) is taking place.

Payment processor 130 (also referred to as a “host”) may include one or more devices that route an authorization/transaction request from transaction device 120 to a particular card association 140. Payment processor 130 may be included, for example, within a customer's private network. In one implementation, payment processor 130 may receive, via transaction network 110, an inquiry (e.g., an authorization request) from transaction device 120 and provide a response (e.g., an approve/decline decision from card issuer 150) to transaction device 120 to facilitate a data transaction.

Card association 140 may include one or more devices that belong to or are associated with, for example, an entity formed to administer and promote credit cards (e.g., Visa, Master Card, etc.).

Card issuer 150 may include one or more devices that belong to or are associated with, for example, a bank or other institution that authorizes a transaction (e.g., verifies that sufficient funds are associated with a credit card, verifies access rights, etc.). In one implementation, card issuer 150 may receive an authorization request that originates from transaction device 120 and provide a response and/or authorization code to approve a transaction.

Network provider 160 may include one or more devices that belong to or are associated with an entity that provides and manages all or a portion of transaction network 110. Network provider 160 may receive fees (e.g., a per-transaction fee, flat fee, etc.) for providing transaction services via transaction network 110.

According to an implementation described herein, a merchant may utilize transaction device 120 to initiate transaction services (e.g., a credit card authorization request), via transaction network 110, originating using either a dial (e.g., voice network) or non-dial (e.g., Internet) connection. Regardless of the originating connection from transaction device 120, transaction network 110 may provide a single interface to payment processor 130.

The exemplary configuration illustrated in FIG. 1 is provided for simplicity. It should be understood that a typical network may include more or fewer devices than illustrated in FIG. 1. For example, network 100, may include thousands of transaction devices 120 via which transactions may be made. In addition, network 100 may include additional elements, such as switches, gateways, routers, etc., that aid in routing data. Also, various functions are described below as being performed by particular components in network 100. In other implementations, various functions described as being performed by one device may be performed by another device or multiple other devices, and/or various functions described as being performed by multiple devices may be combined and performed by a single device.

FIG. 2 provides a diagram of a portion 200 of network 100. As shown in FIG. 2, network portion 200 may include transaction devices 120, payment processor 130, a voice network 205, a public IP network 210, a dial access server 215, a gateway 220, a private IP network 225, a transaction services hub 230, a load balancer 235, an internal user device 240, a customer portal server 245, an entitlement server 250, an alarm server 255, a usage management server 260, a notification server 265, a network capacity server 270, and a provisioning status system 275. Transaction devices 120 and payment processor 130 may include features described above in connection with FIG. 1.

Voice network 205 may transfer voice traffic and/or data traffic. For example, voice network 205 may include a PSTN, a domestic toll-free voice network, and/or an international toll-free voice network.

Public IP network 210 may include a wide area network, an intranet, or a combination of networks that support IP communications. Public IP network 210 may include, for example, an untrusted network, such as the Internet. Public IP network 210 may further include transport and/or network devices such as routers, switches, and/or firewalls.

Dial access server 215 may include one or more devices, for example, to receive circuit-based signals and demodulate voice-band data of the circuit-based signals. The dial access server 215 may extract IP packets for routing (e.g., via a TCP connection) to the appropriate destination, such as transaction services hub 230.

Gateway 220 may include a typical gateway (e.g., to another network), a router, a switch, a firewall, a network interface card (NIC), a hub, a bridge, a proxy server, an optical add-drop multiplexer (OADM), or some other type of device that provides an interface between different networks. In one implementation, gateway 220 may include a hyper-text transfer protocol (HTTP) gateway or a secure socket layer (SSL) gateway to act as intermediary between public IP network 210 and private IP network 225.

Private IP network 225 may provide network services, such as a service for data transfers, voicemail, call blocking, calling card, audio, and/or network conferencing, etc. In some implementations, private IP network 225 may provide redundancy and/or the ability to distribute network loads. For example, private IP network 225 may include an IP network or a multiprotocol label switching (MPLS) network implementing an Interior Gateway Protocol (IGP) or another protocol that implements a minimum cost end-to-end path for routing between nodes. Private IP network 225 may provide one or more interface options to payment processor 130 (e.g., residing on a local customer network).

Transaction services hub 230 may manage transactions from transaction device 120 via voice network 205 and/or from transaction device 120 via public IP network 210 (via gateway 220 and private IP network 225). Transaction services hub 230 may establish/maintain connectivity (e.g., secure TCP/IP sessions) with multiple payment processors 130, may route particular transaction authorization requests from a transaction device 120 to the appropriate payment processor, and may return responses (e.g., from payment processor 130) to the originating transaction device 120. For example, transaction services hub 230 may maintain a persistent socket connection (e.g., multiplexing user sessions over a single TCP session) to payment processor 130, non-persistent socket connections; multiple interfaces to multiple payment processors (e.g., with load balancing and/or failover services), support proprietary host protocols, TCP/IP interfaces, X.25 interfaces, etc. Transaction services hub 230 may also collect data regarding the transactions and provide an interface to retrieve reports based on the collected data.

Load balancer 235 may receive transaction services requests and load balance the requests over devices in transaction services hub. For example, load balancer 235 may forward a received transaction services request to a device within transaction services hub 230 based on available resources (e., processing time), geography, etc. For example, in one implementation, transaction services hub may include multiple redundant components (e.g., with geographic diversity) to enable seamless failover if a particular connection between payment processor 130 and transaction services hub 230 fails.

Generally, internal user device 240, customer portal server 245, entitlement server 250, alarm server 255, usage management server 260, notification server 265, network capacity server 270, and provisioning status system 275 may provide various interfaces to transaction services hub 230. In one implementation, each of internal user devices 240, customer portal server 245, entitlement server 250, alarm server 255, usage management server 260, notification server 265, network capacity server 270, and provisioning status system 275 may be integrated with other systems/services provided by network provider 160. For example, one or more of user device 240, customer portal server 245, entitlement server 250, alarm server 255, usage management server 260, notification server 265, network capacity server 270, and provisioning status system 275, and may provide access to information from multiple services (e.g., wireless services, Internet services, telephone services, etc.) besides transaction services.

User device 240 may provide secure internal access to transaction services hub 230. User device 240 may, for example, allow users (e.g., a network administrator) to communicate with components of transaction services hub 230 via private secure connections. Users may use user device 240 to submit configuration settings, service level agreement (SLA) information, provisioning, etc. related to a particular payment processor 130.

Customer portal server 245 may provide limited external access to transaction services hub 230. For example, customer portal server 245 may enable an authorized customer to access reporting data, residing in transaction services hub 230, that relates to a particular host (e.g., payment processor 130). In one implementation, customer portal server 245 may provide a common web-based interface to access multiple types of services (e.g., transaction services and other services). Access to services via customer portal server 245 may be restricted for example to users with registered accounts and secure passwords.

Entitlement server 250 may control which users (or user accounts) are permitted to access particular services. For example, entitlement server 250 may provide to transaction services hub 230 a file or list of user accounts that are authorized to access particular components of transaction services hub 230 (e.g., via internal user device 240 or customer portal server 245). In one implementation, entitlement server 250 may receive lists of authorized internal and/or external users from another device, such as a device associated with a subscription/account system.

Alarm server 255 may track and disperse alarm information relating to transaction services hub 230. For example, if transaction services hub 230 identifies a problem (e.g., a failed link with a payment processor 130), transaction services hub 230 may signal alarm server 255 to generate alarms to appropriate monitoring systems and/or ticketing systems. In one implementation, alarm server 255 may also consolidate and/or correlate alarms from multiple services (e.g., wireless services, Internet services, and/or transaction services).

Usage management server 260 may track system usage by customers. For example, usage management server 260 may collect transaction statistics from transaction services hub 230 to generate customer invoices. Notification server 265 may generate notifications (e.g., email, text messages, etc.) for customers and/or internal users. For example, notification server 265 may receive indications of service interruptions (e.g., scheduled maintenance, outages, etc.) and automatically send notifications to particular customer accounts.

Network capacity server 270 may assign and track telephone numbers (e.g., tool-free dial numbers) with particular customers. Provisioning status system 275 may track availability of network and/or system resources to support transaction services for particular customers. For example, provisioning status system 275 may track installation of new services, bandwidth availability, ports, paths and/or other information required to support service level agreements with customers.

Although FIG. 2 shows exemplary components of network portion 200, in other implementations, network portion 200 may include fewer, different, differently-arranged, or additional components than those depicted in FIG. 2. Alternatively, or additionally, one or more components of network portion 200 may perform one or more other tasks described as being performed by one or more other components of network portion 200.

FIG. 3 is a diagram that illustrates components of transaction services hub 230. As shown in FIG. 3, transaction services hub 230 may include a transaction services data system 300, a transaction services management system 310, a transaction services reporting system 320, a transaction services tools system 330, and a transaction services database 340.

Transaction services data system 300 may generally be the primary component of transaction services hub 230 for processing customer transactions. Transaction services data system 300 may manage customer traffic (e.g., relay messages relating to transaction services) and provide support functions that are associated with the management of customer traffic. In providing the support functions, transaction services data system 300 may communicate with other components of transaction services hub 230 (e.g., transaction services management system 310, transaction services reporting system 320, etc.), for example, to receive configuration settings and provide transaction statistics. For example, transaction services data system 300 may log information (e.g., origination source, time, etc.) about voice network transaction requests (e.g., via voice network 205) and/or an IP network transaction requests (e.g., via 210) and send the logged information to transaction services tools system 330 and/or transaction services tools database 340. In one implementation, transaction services data system 300 may collect logged information into various data files and push them to the transaction services tools system 330. Logged information may include usage detail records; session detail records; application status records; alarm detail files; and/or log files, crash dumps, or core files from transaction services data system 300 applications. Transaction services data system 300 may also monitor the health status of customer hosts (e.g., each payment processor 130) and gather data related to each processed transaction.

Transaction services management system 310 may provide an internal portal (e.g., a Web-based system for internal users of network provider 160) for service delivery, operations, and marketing related to transaction services provided by transaction services hub 230. For example, transaction services management system 310 may provide for customer provisioning, configuration management, reporting, troubleshooting, and/or SLA management and publishing.

Transaction services reporting system 320 may provide to customers (e.g., users associated with payment processor 130) reporting and/or administrative tools for transaction services provided by transaction network 110. In one implementation, customers may access transaction services reporting system 320 via a customer portal (e.g., a Web-based system for external users of network provider 160). For example, customer portal server 245 may provide a gateway to transaction services reporting system 320. Transaction services reporting system 320 may provide customers with a variety of reporting formats/data and may give customers the ability to manage traffic to particular hosts using, for example, a Web-based interface.

Transaction services tools system 330 may include collector applications and tools applications. The collector applications generally may receive and format data for storage. The tool applications generally may provide a variety of applications to manipulate, process, and/or control reporting of stored data. In one implementation, transaction services tools system 330 may provide interfaces to billing, provisioning, monitoring, customer notification, and enterprise support systems. Transaction services tools system 330 may also include various tools to manage and maintain the other components. In one implementation, transaction services tools system 330 may also communicate with a backend database (e.g., transaction services database 340) to format and store statistics of processed transactions.

Transaction services database 340 may store transaction information collected and/or generated by one or more of transaction services data system 300, transaction services management system 310, transaction services reporting system 320, and transaction services tools system 330. In one implementation, stored information in transaction services database 340 may be retrieved directly by one of transaction services data system 300, transaction services management system 310, transaction services reporting system 320, or transaction services tools system 330. In another implementation, transaction services tools system 330 may process data retrieval requests from the other transaction services hub 230 components. In one implementation, transaction services database 340 may include stored procedures (e.g., subprograms, such as Oracle® Stored Procedures, etc.) to manipulate data. For example, access to transaction services database 340 from transaction services tool system 330 (e.g., based on a user request via transaction services reporting system 320) may be completed using calls to stored procedures to prevent common security breaches, such as SQL injection, etc. Thus, components of transaction services hub 230 may access transaction services database 340 using calls to the stored procedures.

Although FIG. 3 shows exemplary components of transaction services hub 230, in other implementations, transaction services hub 230 may include fewer, different, differently-arranged, or additional components than depicted in FIG. 3. Alternatively, or additionally, one or more components of transaction services hub 230 may perform one or more other tasks described as being performed by one or more other components of transaction services hub 230.

Functional components of transaction services hub 230 (e.g., transaction services data system 300, transaction services management system 310, transaction services reporting system 320, transaction services tools system 330, and transaction services database 340) may be arranged in a distributed and/or redundant network configuration.

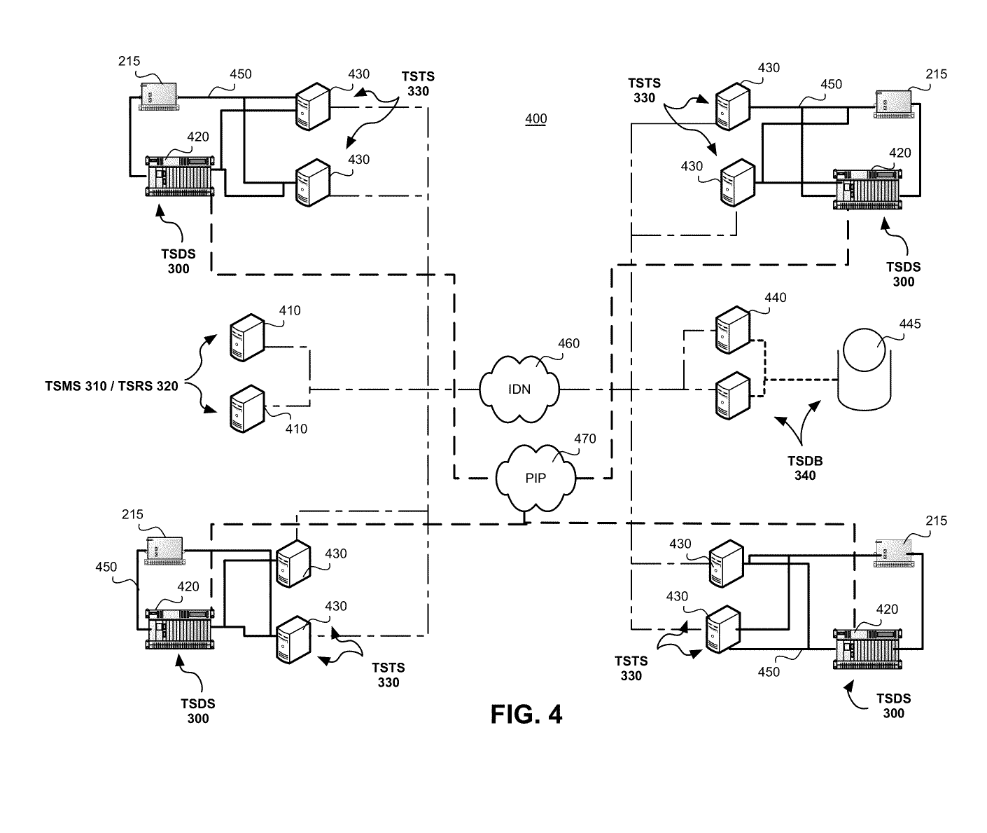

FIG. 4 provides an exemplary network arrangement for a portion 400 of transaction network 110 that may include a distributed configuration for transaction services hub 230. A shown in FIG. 4, network portion 400 may include web servers 410, blade servers 420, tools servers 430, and database servers 440 interconnected by one or more of a LAN connection 450, an internal data network (IDN) connection 460, or a private IP (PIP) network connection 470.

Web servers 410 may perform functions of transaction services management system 310 and/or transaction services reporting system 320. User/customer access (not shown) to web servers 410 may be restricted by network accounts and/or a type of network connectivity. Web servers 410 may communicate with tools servers 430 and/or database servers 440 via IDN connections 460.

Blade servers 420 may each execute a transaction gateway application and other applications to perform functions of transaction services data system 300. There may be multiple instances of blade servers 420 (e.g., providing a primary and a backup role) at each distributed location of transaction services hub 230. Blade servers 420 may communicate with their respective local tools servers 430 and dial access servers 215 via LAN connections 450. For example, by default, blade servers 420 may push data files to tools servers 430 that are at the same location as blade server(s) 420. In another implementation, blade servers 420 may failover and forward data files to tools servers 430 at other locations (e.g., via PIP network connections 470). Blade servers 420 may communicate with other remote blade servers 420 via PIP network connections 470.

Tools servers 430 may execute applications described herein to perform functions of transaction services tools system 330. As shown in FIG. 4, there may multiple instances of tools servers 430 (e.g., providing a primary and a backup role) at each distributed location of transaction services hub 230. Tools servers 430 may communicate locally with each other, local blade servers 420, and local dial access server 215 via LAN connections 450. Tools severs 430 may communicate with remote tools servers 430, web servers 410, and/or database servers 440 via IDN connections 460.

Database servers 440 may execute applications to perform functions of transaction services database 340. Database servers 440 may communicate with web servers 410 and/or tools servers 430 via IDN connections 460. Database servers 440 may also include local connections to one or more databases.

Although FIG. 4 shows exemplary components of network portion 400, in other implementations, network portion 400 may include fewer, different, differently-arranged, or additional components than the ones depicted in FIG. 4. Alternatively, or additionally, one or more components of network portion 400 may perform one or more other tasks described as being performed by one or more other components of network portion 400.

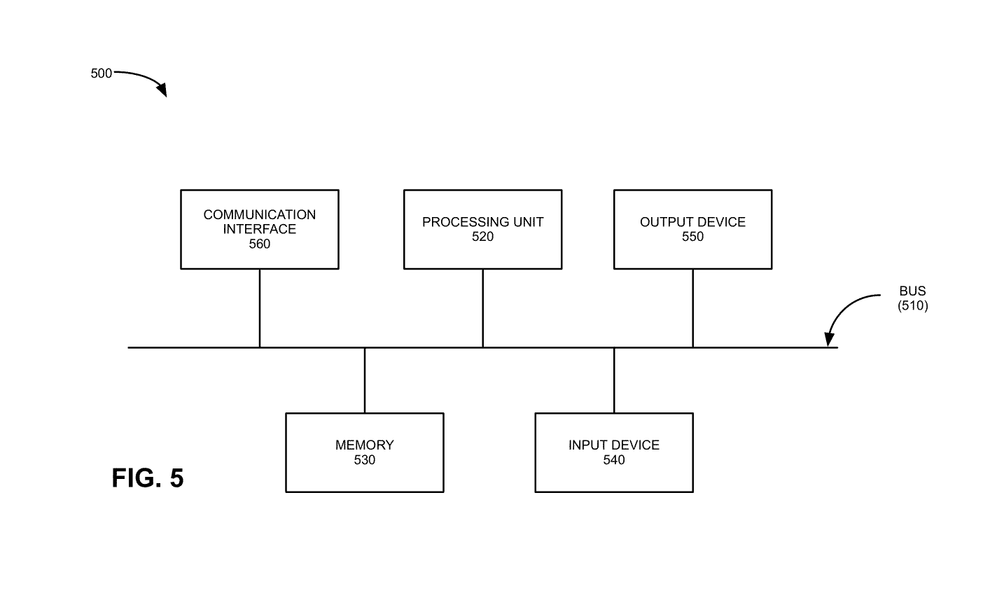

FIG. 5 is a diagram of exemplary components of a device 500. Device 500 may correspond to transaction device 120, payment processor 130, dial access server 215, gateway 220, load balancer 235, user device 240, customer portal server 245, entitlement server 250, alarm server 255, usage management server 260, notification server 265, network capacity server 270, provisioning status system 275, transaction services data system 300, transaction services management system 310, transaction services reporting system 320, transaction services tools system 330, transaction services database 340, web server 410, blade server 420, tools server 430, or database server 440. Each of transaction device 120, payment processor 130, dial access server 215, gateway 220, load balancer 235, user device 240, customer portal server 245, entitlement server 250, alarm server 255, usage management server 260, notification server 265, network capacity server 270, provisioning status system 275, transaction services data system 300, transaction services management system 310, transaction services reporting system 320, transaction services tools system 330, transaction services database 340, web server 410, blade server 420, tools server 430, and database server 440 may include one or more devices 500. As shown in FIG. 5, device 500 may include a bus 510, a processing unit 520, a memory 530, an input device 540, an output device 550, and a communication interface 560.

Bus 510 may permit communication among the components of device 500. Processing unit 520 may include one or more processors or microprocessors that interpret and execute instructions. In other implementations, processing unit 520 may be implemented as or include one or more application specific integrated circuits (ASICs), field programmable gate arrays (FPGAs), or the like.

Memory 530 may include a random access memory (RAM) or another type of dynamic storage device that stores information and instructions for execution by processing unit 520, a read only memory (ROM) or another type of static storage device that stores static information and instructions for execution by processing unit 520, and/or some other type of magnetic or optical recording medium and its corresponding drive for storing information and/or instructions.

Input device 540 may include a device that permits an operator to input information to device 500, such as a keyboard, a keypad, a mouse, a pen, a microphone, one or more biometric mechanisms, or the like. Output device 550 may include a device that outputs information to the operator, such as a display, a speaker, etc.

Communication interface 560 may include a transceiver (e.g., a transmitter and/or receiver) that enables device 500 to communicate with other devices and/or systems. For example, communication interface 560 may include mechanisms for communicating with other devices, such as other devices of network 100 or another device 500.

As described herein, device 500 may perform certain operations in response to processing unit 520 executing software instructions contained in a computer-readable medium, such as memory 530. A computer-readable medium may include a non-transitory memory device. A memory device may include space within a single physical memory device or spread across multiple physical memory devices. The software instructions may be read into memory 530 from another computer-readable medium or from another device via communication interface 560. The software instructions contained in memory 530 may cause processing unit 520 to perform processes described herein. Alternatively, hardwired circuitry may be used in place of or in combination with software instructions to implement processes described herein. Thus, implementations described herein are not limited to any specific combination of hardware circuitry and software.

Although FIG. 5 shows exemplary components of device 500, in other implementations, device 500 may include fewer components, different components, differently arranged components, or additional components than depicted in FIG. 5. As an example, in some implementations, input device 540 and/or output device 550 may not be implemented by device 500. In these situations, device 500 may be a “headless” device that does not explicitly include an input or an output device. Alternatively, or additionally, one or more components of device 500 may perform one or more other tasks described as being performed by one or more other components of device 500.

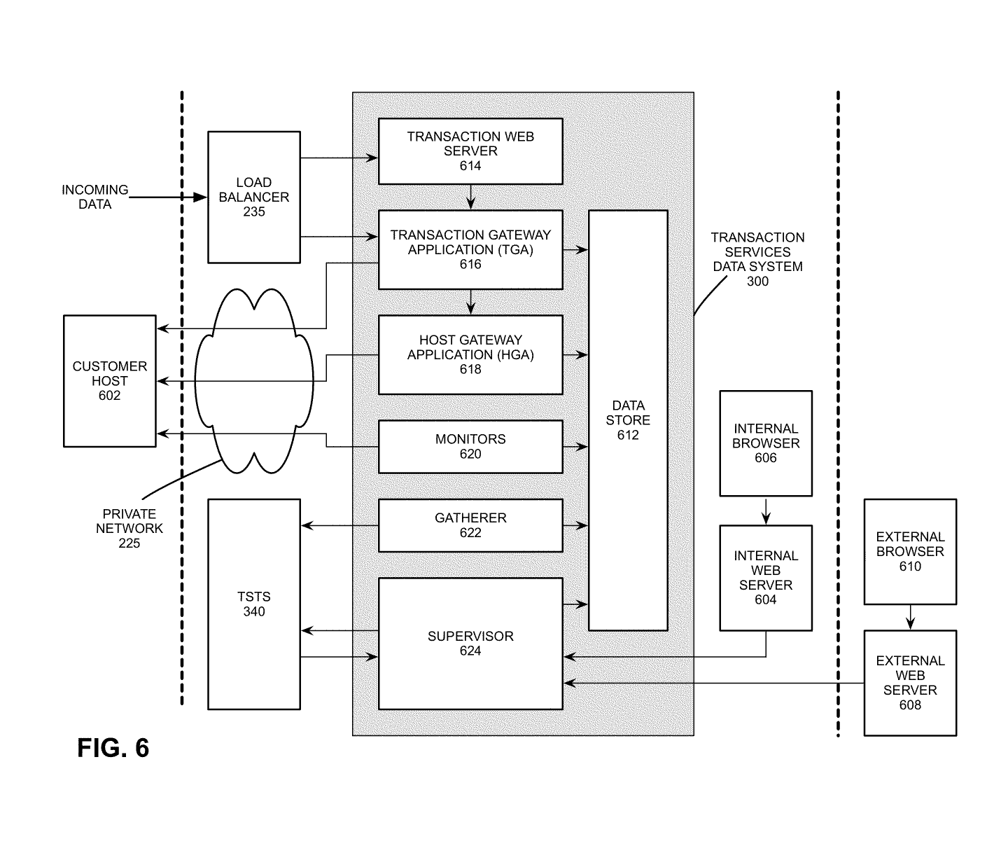

FIG. 6 is a diagram of exemplary components of transaction services data system 300 and a portion of network 200. In FIG. 6, the portion of network 200 is depicted as including a number of devices/components of FIG. 2, customer host 602, internal web server 604, internal browser 606, external web server 608, and external web browser 610. As further shown, transaction services data system 300 includes a transaction web server 614, a transaction gateway application 616, host gateway application 618, one or more monitors 620, gatherer 622, and supervisor 624. Depending on the implementation, transaction services data system 300 may include additional, fewer, different, or differently arranged components than those illustrated in FIG. 6. For example, in some implementations, transaction services data system 300 may include one or more customer hosts 602 and one or more transaction gateway applications 616, each of which corresponds to a particular customer host 602.

Customer host 602 may include a device in payment processor 130. As described above, customer host 602 may route an authorization/transaction request from transaction services data system 300 to a particular card association 140. Upon receipt of a response, to a request for authorization, from card association 140, customer host 602 may respond to transaction services data system 300.

Internal web server 604 includes a server for providing a web interface to internal browser 606. Internal browser 606 may allow a user inside of transaction network 110 to access, control, and configure supervisor 624 via internal web server 604. Both internal web server 604 and internal web browser 606 are within transaction network 110.

Similarly, external web server 608 includes a web server for providing a web interface to external browser 610. External browser 610 may allow a user outside of transaction network 110 to access, control, and configure supervisor 624 via external web server 608. Both external web server 608 and external web browser 610 are outside of transaction network 110.

Data store 612 may store data from transaction gateway application 616, host gateway application 618, monitors 620, gatherer 622, and supervisor 624. The data may include usage detail records, session detail records (e.g., data from transaction gateway application 616 and host gateway application 618), alarms (e.g., alarms generated by transaction gateway application 616, monitors 620, and/or supervisor 624), log files and crash dumps (e.g., files from any application from transaction services data system 300), application status reports (e.g., memory usage, disk usage, etc., written by supervisor 624 for applications that run on transaction services data system 300), etc. For example, a log file from supervisor 624 may include a name of an application running under supervisor 624's command, version of the application, a process ID of the application, a status port at which the application listens for incoming messages, uptime, application status, memory usage, CPU usage, etc.

Transaction web server 614 may accept TCP/IP connections (e.g., HTTP connections, HTTPS connections, etc.) from transaction devices 120 via load balancer 235. Over the connections, transaction web server 614 receives HTTP authorization requests and requests for transaction settlements from transaction devices 120. Upon receipt of a HTTP request/message, transaction web server 614 may remove the HTTP header from the HTTP request/message to obtain a transaction message. Transaction web server 614 may then hand off the transaction message to transaction gateway application 616. When transaction web server 614 receives a transaction response from transaction gateway application 616, transaction web server 614 may add a HTTP/HTTPS header to the transaction response to generate a HTTP/HTTPS response. Transaction web server 614 may send the HTTP/HTTPS response to transaction device 120.

Transaction gateway application 616 may receive transaction messages from transaction web server 614 and other component/devices (e.g., an secure socket layer (SSL) device (not shown) or dial access server 215), process the transaction messages, and identify and forward the processed transaction messages (or other messages resulting from the processing) to corresponding customer hosts 602. Similarly, transaction gateway application 616 may receive responses, to the transaction messages, from customer hosts 602, process the responses to obtain transaction responses, and hand off the transaction responses to transaction web server 614 or another component/device.

In processing a message from transaction web server 614, dial up server 214 or another device, transaction gateway application 616 may apply a specific transaction protocol (e.g., Visa II (Visa2)). Thereafter, transaction gateway application 616 may send the message (or another message resulting from applying the protocol to the message) over an existing session or new session (e.g., a transport protocol data unit (TPDU) session, Visa link protocol (VLP) session, EHEADER session, etc.), via host gateway application 618. Depending on the message, transaction gateway application 616 may send a message over a TPDU session, VLP session or EHEADER session without applying a transaction protocol.

Host gateway application 618 may relay, during a session, communications to/from transaction gateway application 616 from/to customer host 602. Furthermore, in relaying the communications, in some instances, host gateway application 618 may maintain persistent sockets at the both ends of the session (e.g., send keep-alive messages, from one of two sockets of a session, to the other socket). In other instances, host gateway application 618 may create new sessions to relay communications.

Monitors 620 may include a host monitor and a customer monitor. The host monitor may monitor next-hop routers in transaction network 110 (e.g., to ensure network availability), communicate with supervisor 624 to determine health statuses of applications on transaction services data system 300, and respond to health checks from load balancer 235 based on the determined health statuses. The customer monitor may monitor customer hosts (e.g., customer host 602) and applications via pings and/or periodic TCP connections. In addition, the customer monitor may notify transaction gateway application 616 when an application or a host is down. In such instances, transaction gateway application 616 may avoid routing messages to the down applications/hosts.

Gatherer 622 sends information (e.g., files) in data store 612 to transaction services tools system 340. In one implementations, gatherer 622 pushes files to two collectors at the same location (e.g., a device in which the collectors are installed). In case of a failover, gatherer 622 may forward the files to other locations.

Supervisor 624 may manage or administer applications on transaction services data system 300. When supervisor 624 starts up, supervisor 624 requests transaction services tools system 330 to download executables and configuration files. Supervisor 624 may parse the configuration files to determine which applications should be running and how each of those applications should be configured. Supervisor 624 may then start the applications in a specific sequence. Thereafter, supervisor 624 may monitor the applications, and if an application fails or becomes unresponsive, supervisor 624 may restart (or attempt to restart) the failed/unresponsive application.

Supervisor 624 may respond to different components of transaction services hub 230. For example, when transaction services tools system 330 or transaction services management system 310 queries supervisor 624 for an application status, supervisor 624 may respond to the query. In another example, supervisor 624 may act as a proxy for transaction services management system 310 or transaction services tools system 330 to communicate with other transaction services hub 230 applications.

In another example, supervisor 624 may receive a command or an instruction from transaction services tools system 330 or transaction services management system 310 and perform the requested function, such stop/start/restart a single application, stop/start/restart all applications, update an application configuration(s), etc. When transaction services tools system 340 requests supervisor 624 to update application configurations, supervisor 624 may selectively restart applications with new configuration files/data. In some instances, supervisor 624 may issue a command for a selected application to re-read an updated configuration file. In other instances, supervisor 624 may shut down applications that are not longer configured with up-to-date data.

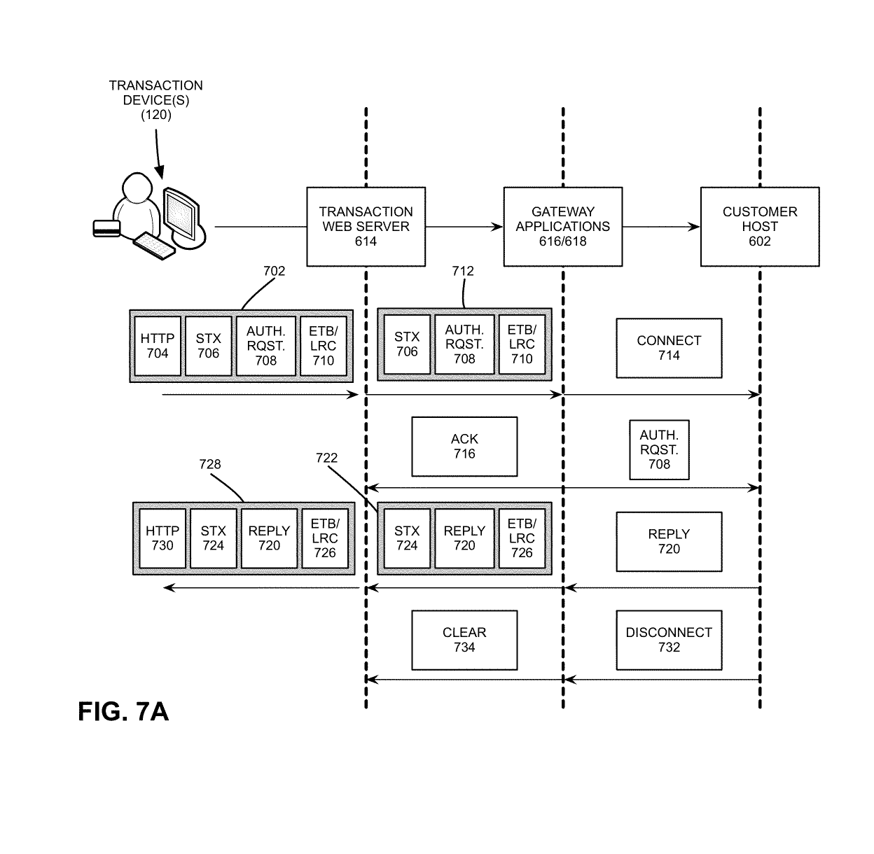

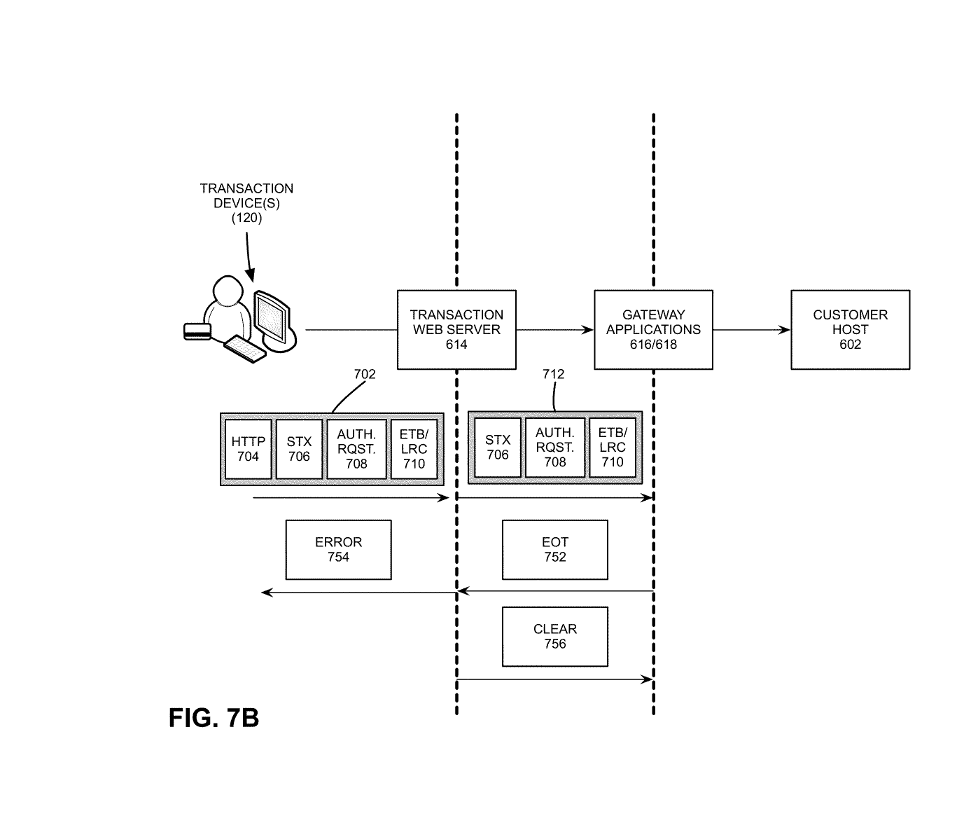

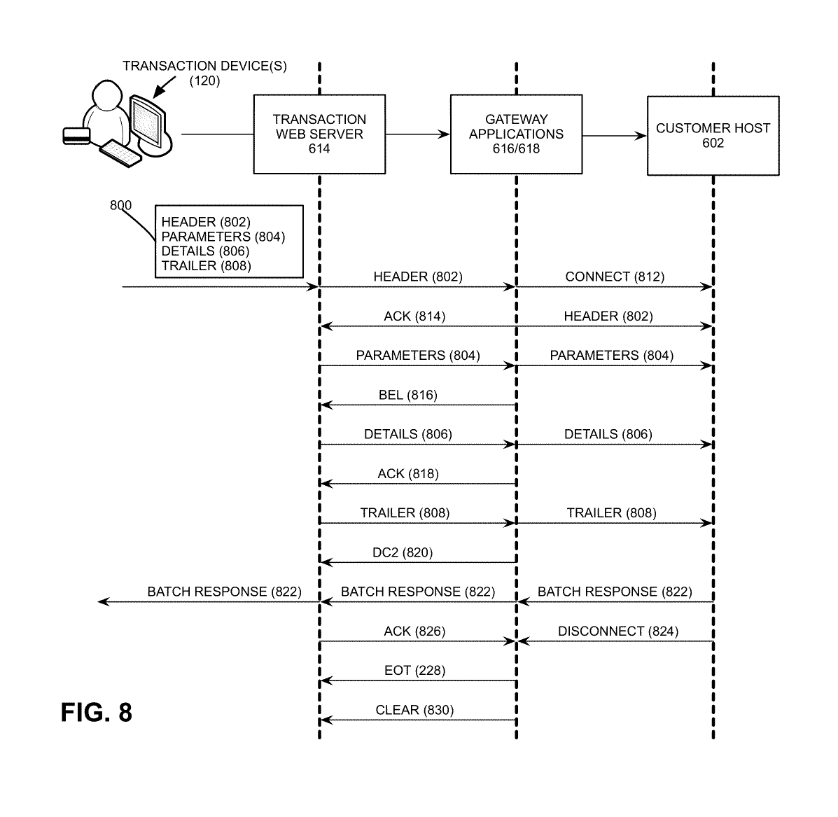

FIGS. 7A, 7B, and 8 are diagrams illustrating exemplary flows of messages between transaction device 120, customer host 602, and components of transaction services data system 300. FIG. 7A is a diagram illustrating an exemplary flow of messages between transaction device 120, customer host 602, and components of transaction services data system 300 when transaction device 120 requests customer host 602 to authorize a transaction. As shown in FIG. 7A, transaction device 120 sends a transaction message 702 to transaction web server 614. As further shown in FIG. 7A, transaction message 702 includes a HTTP/HTTPS header 704, STX control code 706, authorization request 708, and ETB/LRC control code 710.

HTTP/HTTPS header 704 may indicate the start of a HTTP/HTTPS message and that a body of the HTTP message follows the HTTP/HTTPS header 704. STX control code 706 and ETB/LRC control codes 710 indicate the beginning of text and the end of a transmission block. Authorization request 708 may include a user identifier (ID), password, and/or other information that may be used by customer host 602 to authenticate a user and/or authorize a transaction.

As shown in FIG. 7A, upon receipt of transaction message 702, transaction web server 614 strips off HTTP/HTTPS header 704 from transaction message 702 to obtain a modified transaction message 712. Transaction web server 614 forwards modified transaction message 712 to gateway applications 616/618. Upon receipt of modified transaction message 712, gateway applications 616/618, obtain routing information based on modified transaction message 712 and establish or identify a connection 714 to customer host 602 based on the routing information. When the connection is established/identified, gateway applications 616/618 strip off control codes 706 and 710 from modified transaction message 712 to obtain an authorization request 708, send authorization request 708 to customer host 602 and send an acknowledgment (ACK) 716 to transaction web server 614.

When customer host 602 sends a reply 720 to gateway applications 616/618 over the connection, gateway applications 616/618 add control codes STX 724 and ETC/LRC 726 as a header and a trailer, respectively, to reply 720, to obtain a modified reply 722. Gateway applications 616/618 send modified reply 722 to transaction web server 614.

When transaction web server 614 receives modified reply 722, transaction web server 614 adds a HTTP/HTTPS header 730 to modified reply 722 to obtain a HTTP/HTTPS reply 728. Transaction web server 614 forwards HTTP/HTTPS reply 728 to transaction device 120. Once reply 720 (e.g., authorization or denial) has been sent to gateway applications 616/618, customer host 602 may send a disconnect request to gateway applications 616/618. In response, gateway applications 616/618 may de-allocate a socket corresponding to the connection and send a clear message 734 to transaction web server 614.

FIG. 7B is a diagram illustrating another exemplary flow of messages between transaction device 120, customer host 602, and components of transaction services data system 300 when transaction device 120 requests customer host 602 to authorize a transaction. As shown in FIG. 7B, transaction device 120 sends transaction message 702 to transaction web server 614. As in FIG. 7A, upon receipt of transaction message 702, transaction web server 614 strips off HTTP/HTTPS header 704 from transaction message 702 to obtain modified transaction message 712.

When gateway applications 616/618 receive modified transaction message 712, gateway applications 616/618 attempt to obtain routing information. However, in contrast to the example of FIG. 7A, gateway applications 616/618 are unable to obtain a valid network address for customer host 602. Accordingly, gateway applications 616/618 send an end of transmission (EOT) 752 message to transaction web server 614, which then sends an error message indicating that a customer host identifier (e.g., bank identification number (BIN)) is invalid to transaction device 120. In addition, transaction web server 614 may send a clear message 756 to gateway applications 616/618.

Although FIGS. 7A and 7B both involve a request to authorize a transaction, FIGS. 7A and 7B illustrate two different flows of messages. FIG. 7A shows a successful authorization of a transaction. In contrast, FIG. 7B shows a failure to authorize a transaction, because transaction message 702 does not include a valid identifier for customer host 602. Given an authorization request, other message flows are possible, depending on information provided in the authorization request (e.g., bad user ID, bad password, etc.).

FIG. 8 is a diagram illustrating an exemplary flow of messages between transaction device 120, customer host 602, and components of transaction services data system 300 when transaction device 120 performs a settlement with customer host 602. A settlement may occur when payments are credited/debited and/or money is transferred between accounts. In contrast to FIGS. 7A and 7B, for simplicity, FIG. 8 does not illustrate HTTP/HTTPS headers, STX headers. etc. Although not illustrated, such headers may have been added to or removed from messages by transaction web server 614 and/or gateway applications 616/618 as the messages travel through the components/devices in FIG. 8.

As shown, transaction device 120 sends a transaction message 800 to transaction web server 614. As further shown, transaction message 800 may include a header 802, parameters 804, details 806, and a trailer 808. Depending on the implementation, a transaction message may include additional, fewer, different, or differently arranged components than those illustrated in FIG. 8. Header 802 and trailer 808 may mark the beginning and the end, respectively, of a transaction message that requests a settlement. Parameters 804 and details 806 may include information about the transaction.

In FIG. 8, when transaction web server 614 receives transaction message 800, transaction web server 614 may partition the message into components 802-808, and may transmit them in sequence (depending on the reply from customer host 602). As shown, transaction web server 614 transmits header 802 first to gateway applications 616/618. Gateway applications 616/618 then open a connection 812 to customer host 602. If connection 812 is successfully opened, gateway applications 616/618 send an acknowledgment (ACK) 814 to transaction web server 614 and send header 802 to customer host 602.

When transaction web server 614 receives ACK 814, transaction web server 614 sends parameters 804 to gateway applications 616/618, which send a bell (BEL) response 816 to transaction web server 614 and forward parameters 804 to customer host 602. BEL response 816 may indicate that gateway applications 616/618 have forwarded parameters 804 to customer host 602.

Upon receipt of BEL response 816, transaction web server 614 sends details 806 to gateway applications 616/618. In response, gateway applications 616/618 forward details 806 to customer host 602 and send an acknowledgment (ACK) 818 to transaction web server 614. ACK 818 may indicate that gateway applications 616/618 have forwarded details 806 to customer host 602.

Upon receipt of ACK 818, transaction web server 614 sends trailer 808 to gateway applications 616/618. In response, gateway applications 616/618 forward trailer 808 to customer host 602 and send a device control 2 (DC2) response 820. DC2 response 820 may indicate that gateway applications 616/618 have forwarded trailer 808 to customer host 602.

When customer host 602 receives trailer 808, customer host 602 performs functions that are necessary to settle or complete the transaction. If the transaction is successfully settled, customer host 602 sends a batch response 822 to gateway applications 616/618. In addition, customer host 602 performs a disconnect 824 from gateway applications 616/618. Batch response 822 travels through gateway applications 616/618 and transaction web server 614 to transaction device 120. Along the way, when batch response 822 reaches transaction web server 614, transaction web server 614 sends an acknowledgment 826 to gateway applications 616/618. To conclude the transaction, gateway applications 616/618 sends end-of-transmission (EOT) message 828 and clear message 830 to transaction web server 614.

In FIGS. 7A, 7B, and 8, gateway applications 616/618 are illustrated as receiving message 702 and message 800 from transaction device 120 through transaction web server 614. Depending on transaction device 120, messages from transaction device 120 may be routed to, gateway applications 616/618 components/devices other than transaction web server 614, such as dial access server 215, an SSL server/device, etc.

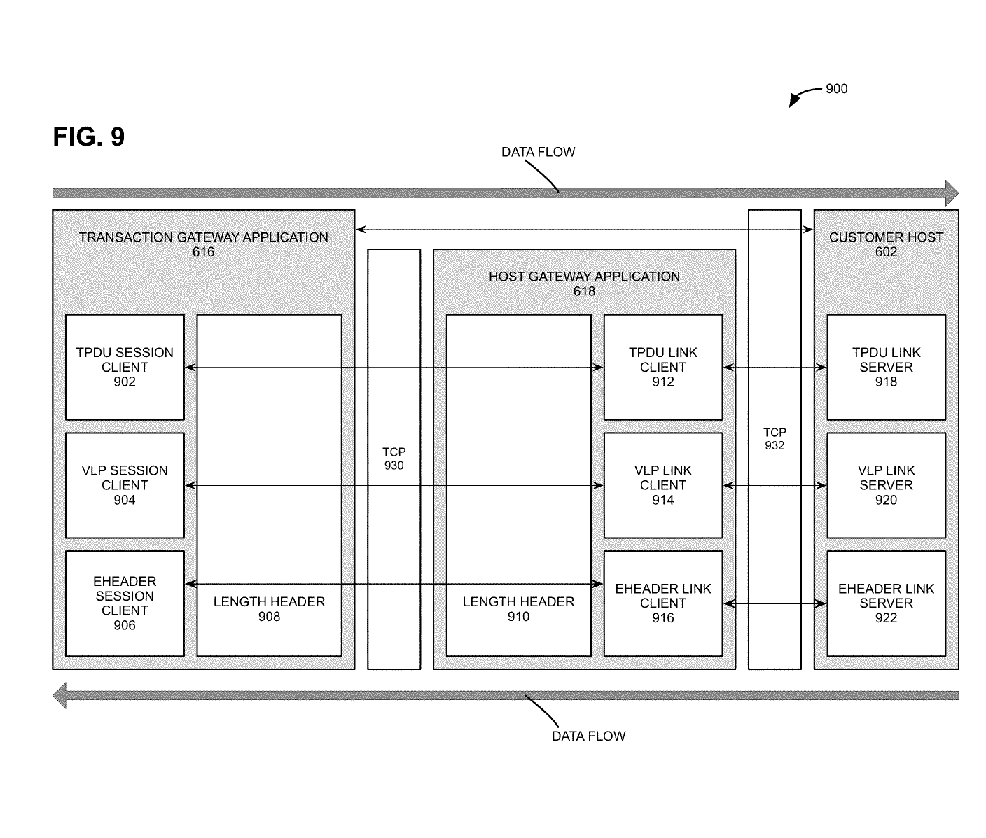

FIG. 9 is a diagram 900 illustrating flows of data through different components of transaction gateway application 616, host gateway application 618, and customer host 602. Diagram 900 shows additional details that are associated with gateway applications 616/618 handling incoming and outgoing messages, such as the messages illustrated in FIGS. 7A, 7B, and 8. Assume that transaction gateway application 616 receives/sends data from/to transaction web server 614, a SSL gateway/server, dial access server 215, or another component/device conducting a transaction with customer host 602.

When transaction gateway application 616 receives a message from a transaction device 120 (e.g., via transaction web server 614, dial access server 215, etc.), in some instances, transaction gateway application 616 may also identify a communication protocol under which transaction gateway application 616 is to handle the message (or a portion of the message). In other instances, the message may be associated with a predetermined communication protocol and may be directly received by a component (e.g., TPDU session client 902, VLP session client 904, EHEADER session client 906, etc.). The identified or preselected communication protocol may be one of: transport protocol data unit (TPDU) protocol, Visa link protocol (VLP), and EHEADER protocol.

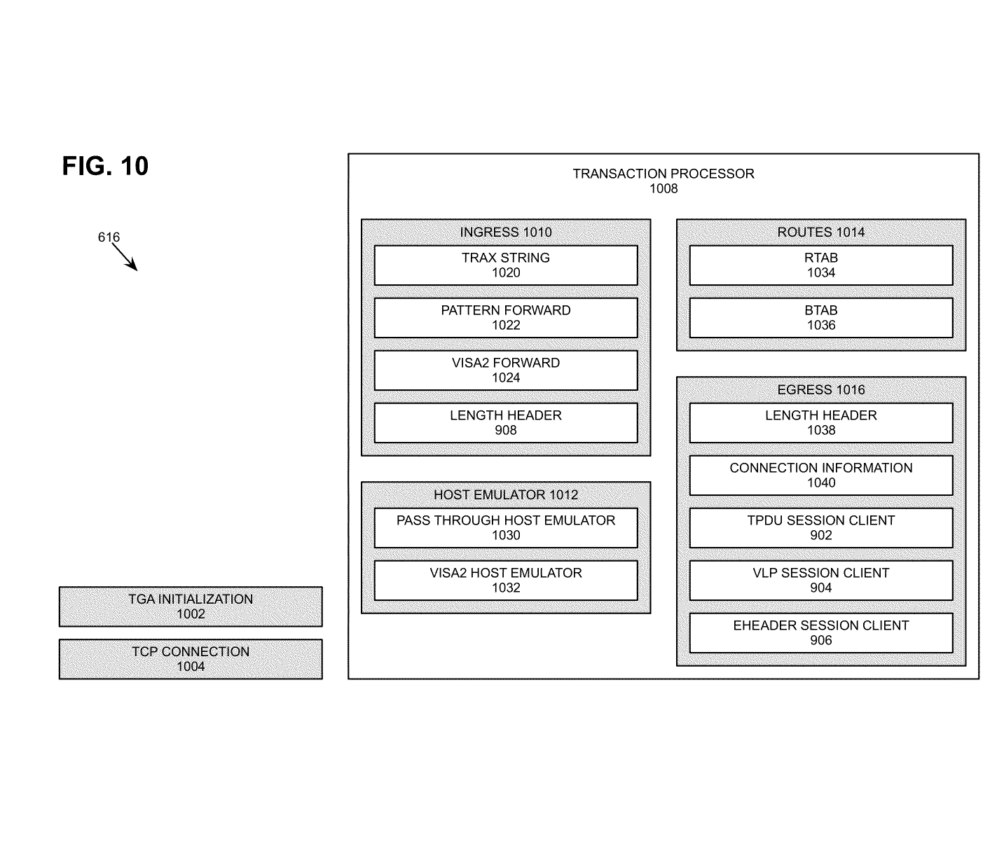

After the receipt of the message, transaction gateway application 616 may process the message as one of a TPDU packet, VLP packet, or EHEADER packet. Depending on the identified/predetermined communication protocol, transaction gateway application 616 may handle the message via one of its components: TPDU session client 902, VLP session client 904, and EHEADER client 906. These components are described below in greater detail with reference to FIG. 10.

After the processing, transaction gateway application 616 may pass a message that is output by TPDU session client 902, VLP session client 904, or EHEADER client 906 to length header 908. Length header 908 may add additional header information to the message. Length header 908 is described below in greater detail with reference to FIG. 10. Transaction gateway application 616 forwards the message output from length header 908 to host gateway application 618 via TCP link 930 between transaction gateway application 616 and host gateway application 618.

Transaction gateway application 616 may also receive a message from host gateway application 618. Depending on the communication protocol, the message may be received at TPDU session client 902, VLP session client 904, or EHEADER session client 906. In each of these cases, when the message arrives at transaction gateway application 616, length header 908 reads the message header (or the packet header) to obtain length information and uses the header information to obtain a body (or the payload) of the message. Each of TPDU session client 902, VLP session client 904, and EHEADER session client 906 processes the body of the message, and dispatches an appropriate message in accordance with its own communication protocol to transaction web server 614, dial access server 215, or to another device.

Host gateway application 618 may receive a message from either transaction gateway application 616 or customer host 602. When a message arrives from transaction gateway application 616, depending on the communication protocol under which the message is received, one of its components for handling the specific protocol, TPDU link client 612, VLP link client, EHEADER link client 916, may receive the message. Furthermore, a length header 910, which plays a similar role as length header 908 in transaction gateway application 908, reads the message header (or the packet header) and uses the header information to obtain a body of the message/packet. Each of TPDU link client 912, VLP link client 914, and EHEADER link client 916 processes the body of the message, and dispatches an appropriate message in accordance with the communication protocol, to customer host 602 over TCP link 932. TPDU link client 912, VLP link client 914, and EHEADER link client 916 are described below in greater detail with reference to FIG. 10.

When a message arrives from customer host 602 at host gateway application 618, one of TPDU link client 912, VLP link client 914, and EHEADER link client 916 receives the message and handles/processes the message, depending on the communication protocol of the message. Host gateway application 618 passes a message output by one of TPDU link client 912, VLP link client 914, and EHEADER link client 916 to length header 910. Length header 910 adds additional header information to the message. Host gateway application 618 forwards the message output from length header 910 to transaction gateway application 616 via TCP link 930.

Customer host 602 may receive a message from host gateway application 618. Depending on the communication protocol of the message, customer host 602 may process the message via TPDU link server 918, VLP link server 920, and EHEADER link server 922 and send a reply to host gateway application 618.

FIG. 10 is a block diagram of exemplary functional components of transaction gateway application 616. As shown, transaction gateway application 616 may include a TGA initialization component 1002, TCP connection 1004, and transaction processor 1008. Depending on the implementation, transaction gateway application 616 may include additional, fewer, different, or differently arranged components than those illustrated in FIG. 10.

TGA initialization component 1002 may configure a corresponding transaction gateway application 616 when transaction gateway application 616 is instantiated. TGA initialization component 1002 may identify a blade on which transaction gateway application 616 is to be instantiated, a list of ingress TCP ports, and, in some cases, the name of a configuration file/database. In some implementations, TGA initialization component 1002 may provide for a command line interface for dynamically reconfiguring transaction gateway application 616.

TCP connection component 1004 may include a wrapper for TCP connections. TCP connection component 1004 may be instantiated with a number of parameters, such as the name/identifier of a callback function to which received data (by TCP connection 1004) will be passed, the name/identifier of a callback function which is invoked when the connection closes, the size of a chunk of data to be read from the socket at a time, the size of queue for transmission, etc.

In addition, TCP connection component 1004 may be instantiated with an existing socket or instantiated with information on what destination device/port to connect to. TCP connection component 1004 may include methods for instructing the connection to, for example: send/transmit data; start reading data or stop scanning (reading) data; and close the connection.

Transaction processor 1008 may correspond to a single transaction session. Transaction processor 1008 is instantiated when a transaction session begins and is deleted or freed when the transaction session ends. Transaction processor 1008 may include methods for sending data to transaction device 120 (e.g., called by host emulator 1012); receiving data from transaction device 120 (e.g., called by ingress 1010); sending data to customer host 602 (e.g., called by host emulator 1012); receiving data from customer host 602 (e.g., called by egress 1016); etc. Depending on the implementation, transaction processor 1008 may include other components and/or methods.

As shown in FIG. 10, transaction processor 1008 may include ingress 1010, host emulator 1012, routes 1014, and egress 1016. Depending on the implementation, transaction processor 1008 may include additional, fewer, different, or differently arranged components than those illustrated in FIG. 10.

Ingress 1010 may include a server for serving transaction devices 120, dial access server(s) 215, and other devices. As used herein the term “terminal” may refer to transaction device 120. As indicated above, transaction device 120 may communicate with transaction services data system 300 via transaction web server 614, dial access server 214, or another device. Ingress 1010 may receive as well as send data/messages from/to the terminal.

Ingress 1010 may be associated with methods for constructing ingress 1010 with a TCP connection 1004 and filtering components used during receiving and sending data. As further shown, the filters may include transaction (TRAX) string filter 1020, pattern forward filter 1022, Visa2 forward filter 1024, and length header 908. Depending on the implementation, ingress 1010 may include additional, fewer, or different components than those illustrated in FIG. 10.

TRAX string filter 1020 may include components and methods for receiving a message and identifying a transaction information string within the message header or the message body. The transaction information string may include information that has been placed inside the message by another component, such as dial access server 215 or transaction web server 614. A typical transaction information string may include an automatic number identification (ANI), dialed number identification (DNI), BAUD rate (for transactions initiated through calls), etc.

Pattern forward filter 1022 may include components and methods for receiving a message and identifying a pattern of symbols/characters within the message header or the message body. The pattern may be specified (e.g, by a user or network operator) via a regular expression. When pattern forward filter 1022 finds a pattern in data, pattern forward filter 1022 returns the data.

Visa2 forward filter 1024 may include components and methods for detecting a Visa2 frame within a message. When Visa2 forward filter 1024 detects a Visa2 frame within the message, Visa2 forward filter 1024 returns the detected frame.

Length header 908 may include components and methods for sending a packet of data of a given size and for receiving a packet of data. When length header 908 receives data (provided by another component or from a network), length header 908 examines the header (herein referred to as “LENGTH_HEADER”) to determine the size of the data and returns the payload/body of the data. When length header 908 sends data, length header 908 may augment the data with a header (e.g., LENGTH_HEADER) that specifies the size of the data and may transmit the augmented data. In some implementations, LENGTH_HEADER is two bytes long.

Host emulator 1012 may emulate customer host 602. When host emulator 1012 is emulating customer host 602 for a given transaction, transaction processor 1008 may concurrently perform other tasks that are related to the transaction (e.g., communicating with customer host 602), to increase the perceived responsiveness of customer host 602 (e.g., decrease the response time) to the terminal.

As shown, host emulator 1012 includes a pass through host emulator 1030 and Visa2 host emulator 1032. Pass through emulator 1030 may allow data to simply pass through host emulator 1012. Visa2 host emulator 1032 may emulate many aspects of Visa2 protocol, to provide efficient processing of a single credit, multi-credit, data capture, interleaved transaction, etc. When host emulator 1012 emulates a host via Visa2 host emulator 1032, ingress 1010 filters data via Visa2 forward filter 1024. In some instances, Visa2 host emulator 1032 may partially emulate a Visa2 host.

Visa2 host emulator 1032 may be configured with different options and/or parameters. For example, Visa2 host emulator 1032 may be set to emulate a host in a enquiry (ENQ)-only mode. An ENQ message is a query that requests a device or a component whether the device/component is ready to provide service. In the ENQ-only mode, the host emulation is performed only long enough to elicit a transaction request from the terminal (e.g., by sending an ENQ message). In another mode, Visa2 host emulator 1032 may be configured not only to elicit an ENQ request from the terminal, but also test integrity of a frame of a transaction request from the terminal. Other options may include changing a timer value for waiting for messages from customer host 602, changing the way in which Visa2 host emulator interprets a message from customer host 602 (e.g., an end-of-transmission block (ETB) may indicate a capture), etc.

Visa2 host emulator 1032 may include methods for receiving data from a terminal; receiving data from customer host 602; sending framed data (e.g., data that is formatted to include a Visa2-compliant frame) to customer host 602 or to a terminal; removing a frame from Visa2 message; framing a message to obtain a Visa2 message; sending an acknowledgment (ACK) to a terminal; etc. Depending on the implementation, Visa2 host emulator 1032 may include additional, fewer, or different methods than the ones described herein.

In sending messages in accordance with Visa2, host emulator 1012 may map a bank identification number or another identifier to a particular customer host 602. In order to perform the mapping, Visa2 host emulator 1032 may consult (e.g., perform look ups) routes 1014, which may provide the required routing information.

Routes 1014 may include components and methods for performing route look ups for the destination of a message (e.g., customer host 602). A route lookup may include look ups of the destination from a routing table (RTABS) and look up of RTABS from bank identification number (BIN) tables (BTABS) and other types of tables. Each of the tables may be implemented as a database table (e.g., a SQL database) or another data structure (e.g., hash table, a linked list, etc.). Routes 1014 may include methods for obtaining a destination address based on a BTAB 1036; connecting to RTAB 1034 (when it is implemented as a SQL database); obtain an entry in a RTAB 1034 based on a BIN and RTAB 1034; etc.

As shown, routes 1014 may include RTAB 1034 and BTAB 1036. RTAB 1034 includes a list of customer host destinations and methods to select one of the destinations. In the list, each destination may be specified by a set of parameters. The parameters may include, for example, an IP address that is associated with a particular egress 1016, a destination IP address, a destination port, and the communication protocol (e.g., TPDU session client 902). To select one of the destinations, RTAB 1034 may use weights, each of which is associated with one of the destinations.

BTAB 1036 includes information for obtaining a mapping between a range of BINS and an RTAB. In some instances, the mapping may be obtained by a direct lookup of BTAB 1036. In other instances, the mapping may be obtained by lookup of BTAB 1036 and other tables.

Egress 1016 may include a client to customer host 602. Egress 1016 may send as well as receive messages to/from customer host 602, via host gateway application 618. Egress 1016 may be associated with methods for constructing egress 1016, changing the parity of data to be transmitted to customer host 602, receive a connection, etc.

As further shown in FIG. 10, egress 1016 includes length header 1038, connection information component 1040, TPDU session client 902, VLP session client 904, and EHEADER session client 906. Depending on the implementation, egress 1016 may include additional, fewer, different, or different arranged components than those illustrated in FIG. 10.

Length header 1038 may include components and methods that are similar to those described above with respect to length header 908. In addition, length header 1038 may operate similarly as length header 908 described above, but for egress 1016.

Connection information component 1040, associated with host gateway application 618, may include information about customer host 602 to which a connection is to be made or has been made. Connection information component 1040 may be assembled based on information received from customer host 602. Connection information component 1040 may include, for example, a virtual connection identifier (VCN ID) or VLAN ID, an IP address that is associated with egress 1016, an IP address of a socket on customer host 602, etc.

TPDU session client 902 includes a client side component for a TPDU protocol communication link between transaction gateway application 616 and customer host 602 (via host gateway application 618). TPDU session client 902 may send the following types of messages in accordance with the TPDU protocol, to customer host 602, via host gateway application 618: a message to indicate/acknowledge the start of a session; a transaction request for each request received from a terminal; a notification, to customer host 602, indicating that a connection to a terminal is terminated; etc. In addition, TPDU session client 902 may receive a response packet from customer host 602 and a no-response packet (a packet that indicates no response is to be sent to the terminal) from customer host 602.

TPDU session client 902 may be associated with methods for: creating or instantiating TPDU session client 902; sending data to customer host 602, via host gateway application 618; receiving data from customer host 602 via host gateway application 618; sending a disconnect message to customer host 602; and sending a notification to customer host 602 to indicate that a connection to a terminal is terminated.

VLP session client 904 includes a client side component for a VLP protocol communication link between transaction gateway application 616 and customer host 602. VLP session client 904 may send the following types of messages in accordance with the VLP protocol to customer host 602, via host gateway application 618: a command to initialize a session and send data from a first request (received from a terminal) to customer host 602; an acknowledgment in response to receiving a message from customer host 602; and data, from the terminal, following the initial request from the terminal. In addition, VLP session client 904 may receive a bring down command or data from customer host 602.

In one implementation, VLP session client 904 may be associated with a method for: creating a VLP session client 904, receiving data from customer host 602; and sending data to customer host 602.

EHEADER session client 906 includes a client side component for a EHEADER protocol communication link between transaction gateway application 616 and customer host 602. EHEADER session client 906 may send and/or receive messages for starting a transaction, stop transaction, and continue a transaction. EHEADER session client 906 may be associated with a method for: instantiating/creating EHEADER session client 906; receiving data/messages; sending data/messages: and/or disconnecting from customer host 602 (e.g., send a bring down command to customer host 602).

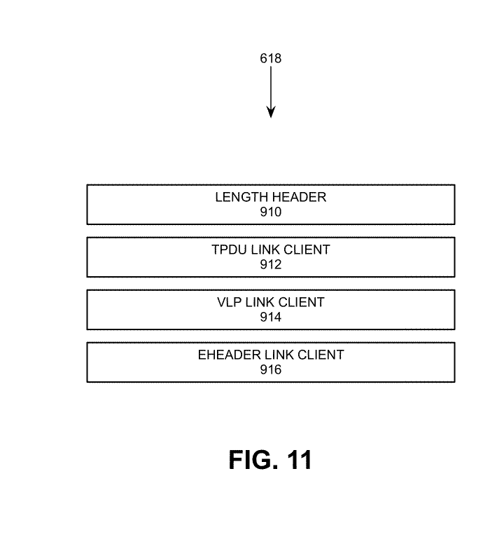

FIG. 11 is a block diagram of exemplary functional components of host gateway application 618. Host gateway application 618 maintains persistent sockets, each of which may outlast a single transaction. Depending on a request received from a terminal, in some instances, host gateway application 618 may select and use an existing, persistent socket, rather than creating a new socket. In other instances, host gateway application 618 may create a new socket for a requested transaction. If a persistent socket goes down (e.g., becomes no longer functional), host gateway application 618 may delete/de-allocate and recreate the persistent socket.

As shown, host gateway application 618 may include a length header 910, TPDU link client 912, VLP link client 914, and EHEADER link client 916. Depending on the implementation, host gateway application 618 may include additional, fewer, different, or differently arranged components than those illustrated in FIG. 11.

Length header 910 may be associated with a method for: receiving data from one of session clients 902-906, de-capsulating the data, and forwarding the de-capsulated data to a corresponding one of link clients 912-916. In addition, length header 910 may include a method for encapsulating data from one of link clients 912-916 and forwarding the encapsulated data to the corresponding one of session clients 902-906. These methods may be invoked or triggered upon receipt of data/messages from session clients 902-906 or customer host 602. One of the link clients (one of TPDU link client 912, VLP link client 914, and EHEADER link client 916) may send a VCN ID to the connection requesting component at transaction gateway application 616, so that transaction gateway application 616 can give the VCN ID to one of the session clients (e.g., VLP session client 904).

When transaction processor 1008 detects that one of link clients 912-916 closes a connection, length header 910 notifies the corresponding session client 902, 904, or 906. Similarly, when length header 910 recognizes that one of session clients 902-906 is down, length header 910 deregisters from a corresponding one of link clients 912-916.

TPDU link client 912 may establish a TCP connection with customer host 602 via TPDU link server 918 on customer host 602. When the TCP connection is up, a corresponding listener socket on host gateway application 618 may begin to accept new TCP connections from TPDU session client 902. When a connection to customer host 602 goes down, TPDU link client 912 may shut the corresponding TCP listener socket at host gateway application 918 (so that transaction gateway application 916 no longer attempts to connect to the listener socket).

TPDU link client 912 may manage a pool of VCN IDs. TPDU link client 912 may allocate/dole out a VCN ID upon establishing a connection to TPDU session client 901, and de-allocate the VCN ID (return the ID to the pool) when the connection is terminated.

TPDU link client 912 may forward TPDU packets received from length header 910 to customer host 602; read TPDU packets from a TPDU link, and forward the TPDU packets to corresponding TPDU session client 902. In addition, TPDU link client 912 may send polling packets to customer host 602 when a link to customer host 602 has been idle for too long (e.g., greater than a threshold time); respond to polling packets; and handle dropped TPDU connections between TPDU link client 912 and transaction gateway application 616.

TPDU link client 912 may include methods that are invoked by transaction processor 1008, for connecting to TPDU session client 902; disconnecting from a connection; receiving data from a TPDU session client 902 and forwarding the data to customer host 602; and receiving data from customer host 602 and forwarding the data to a corresponding TPDU session client 902.

VLP link client 914 may operate similarly as TPDU link client 912. Accordingly, VLP link client 914 may establish a TCP connection to customer host 602, via VLP link server 920 on customer host 602. When the TCP connection is up, a corresponding listener socket on host gateway application 618 may begin to accept new TCP connections from VLP session client 904. When a connection to customer host 602 goes down, VLP link client 914 may shut the corresponding TCP listener socket at host gateway application 918 (so that transaction gateway application 916 no longer attempts to connect to the listener socket).

VLP link client 914 may manage a pool of VCN IDs. VLP link client 914 may allocate/dole out a VCN ID upon establishing a connection to VLP session client 904, and de-allocate the VCN ID (return the ID to the pool) when the connection is terminated.

VLP link client 914 may forward VLP packets received from length header 910 to customer host 602; read VLP packets from a VLP link; and forward the VLP packets to corresponding VLP session client 904. In addition, VLP link client 914 may send polling packets to customer host 602 when a link/connection to customer host 602 has been idle for too long; respond to polling packets; and handle dropped VLP connections between VLP link client 914 and transaction gateway application 616.

VLP link client 914 may include methods that are invoked by transaction processor 1008, for connecting to VLP session client 904; disconnecting from a connection; receiving data from a VLP session client 904 and forwarding the data to customer host 602; and receiving data from customer host 602 and forwarding the data to a corresponding VLP session client 904.

EHEADER link client 916 may operate similarly as TPDU link client 912. Accordingly, EHEADER link client 916 may establish a TCP connection to customer host 602 via a EHEADER link server 922. When the TCP connection is up, a corresponding listener socket on host gateway application 618 may begin to accept new TCP connections from EHEADER session client 906. When a connection to customer host 602 goes down, EHEADER link client 916 may shut the corresponding TCP listener socket at host gateway application 918 (so that transaction gateway application 916 no longer attempts to connect to the listener socket).

EHEADER link client 916 may manage a pool of VCN IDs. EHEADER link client 916 may allocate/dole out a VCN ID upon establishing a connection to EHEADER session client 906, and de-allocate the VCN ID (return the ID to the pool) when the connection is terminated.

EHEADER link client 916 may forward EHEADER packets received from length header 910 to customer host 602; read EHEADER packets from EHEADER link; and forward the EHEADER packets to corresponding EHEADER session client 906. In addition, EHEADER link client 916 may send polling packets to customer host 602 when a connection to customer host 602 has been idle for too long; respond to polling packets; and handle dropped EHEADER connections between EHEADER link client 916 and transaction gateway application 616.

EHEADER link client 916 may include methods that are invoked by transaction processor 1008, for connecting to EHEADER session client 906; disconnecting from a connection; receiving data from EHEADER session client 906 and forwarding the data to customer host 602; and receiving data from customer host 602 and forwarding the data to a corresponding EHEADER session client 906.

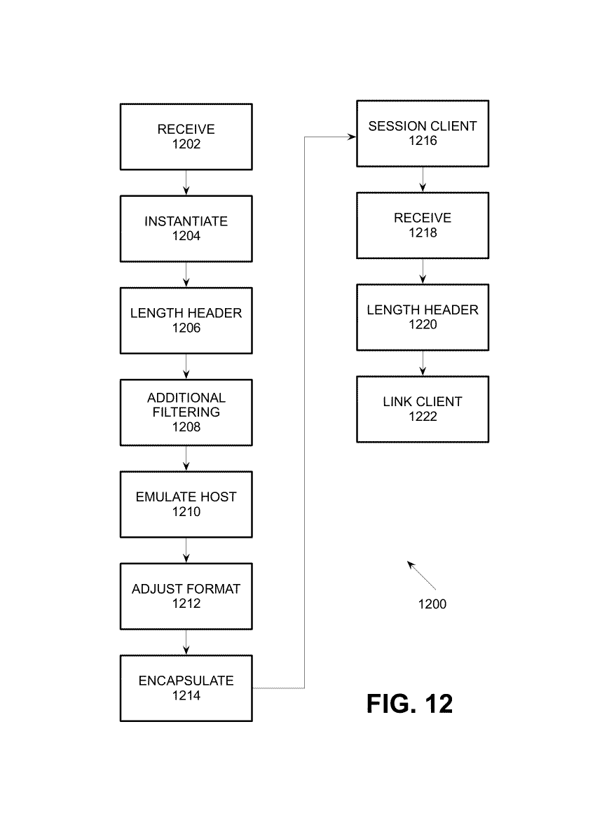

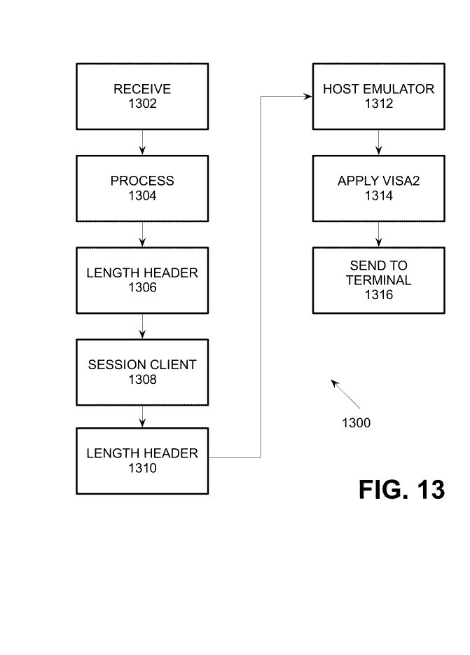

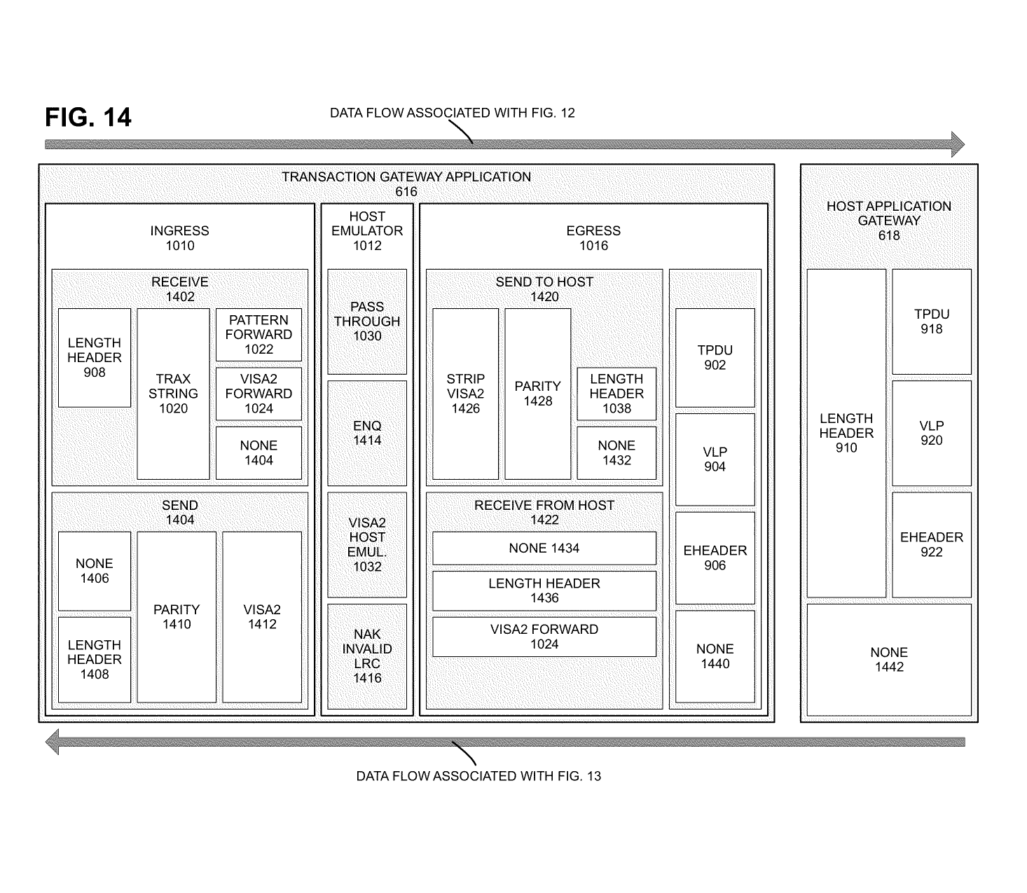

FIG. 12 is a flow diagram of an exemplary process 1200 that is associated with flows of data through different components of transaction gateway application 616 and host gateway application 618. More specifically, process 1200 is associated with flows of data from a terminal to customer host 602 through components of transaction gateway application 616 and host gateway application 618. Below, process 1200 is described with reference to FIG. 12 and FIG. 14. FIG. 14 is a diagram illustrating exemplary flows of data via different components and methods associated with transaction gateway application 616 and host gateway application 618.

Process 1200 may include transaction gateway application 616 receiving a message (block 1202). Upon receipt of the message, transaction gateway application 616 may instantiate a transaction processor 1008 (block 1204), obtain a length header of the message (length header 908 in FIG. 14), and use the length header to obtain a payload/body of the message (block 1206). As shown in FIG. 14, the message may first arrive at ingress 1010 of transaction gateway application 616 via a receive method 1402.

Transaction gateway application 616 may perform additional filtering, such as extracting a transaction information string (e.g., via TRAX string filter 1020 in FIG. 14), detecting a pattern (e.g., via pattern forward filter 1022 or Visa2 forward filter 1024 in FIG. 14), etc. via receive method 1402 (block 1208). In some situations, transaction gateway application 616 may send the output from TRAX string filter 1020 to through none filter 1404.

Transaction gateway application 616 may pass the payload/body of the message to host emulator 1012 (FIG. 14). Host emulator 1012 may emulate customer host 602 (block 1210) for example, via Visa2 host emulator 1032. In some instances, host emulator 1012 may provide a host response to a message, such as an ENQ response 1414 (FIG. 14), NAK response 1416 (FIG. 14), etc. Alternatively, host emulator 1012 may not emulate a host, passing the data via pass through host emulator 1030.

Host emulator 1012 may convey data that results from host emulator 1012 to egress 1016 via send to host method 1420. Egress 1016 may adjust the format of the conveyed data (block 1212). Adjusting the format may include stripping a Visa2 header/frame 1426, modifying the parity of the data 1428, etc. Thereafter, transaction gateway application 616 may send the data via length header 1038, which encapsulates the data with a header (e.g., a header indicating the length of the data) (block 1214) or none filter 1432, which does not modify the message. In encapsulating the data, transaction gateway application 616 may perform a look up of the destination address. Transaction gateway application 616 may send the encapsulated data via one of TPDU session client 902, VLP session client 904, EHEADER session client 906 or none 1440 to host gateway application 618 (block 1216).

Host application gateway 618 may receive the encapsulated data from egress 1016 via length header 910, which de-capsulates/packetizes the data (e.g., determines the size of the data and strips off the length header) (block 1220). Length header 910 may then send the de-capsulated data to customer host 602 via one of TPDU link client 918, VLP link client 920, or EHEADER link client 922 (block 1222). Alternatively, the data may simply bypass length header 910 through none 1442.

FIG. 13 is a flow diagram of an exemplary process 1300 that is associated with flows of data through different components of transaction gateway application 616 and host gateway application 618. More specifically, process 1300 is associated with flows of data from customer host 602 to a terminal through host gateway application 618 and transaction gateway application 616. Below, process 1300 is described with reference to FIG. 14.

When customer host 602 sends a message to host gateway application 618, one of TPDU link client 918, VLP link client 920, or EHEADER link client 922 may receive the message (block 1302). Alternatively, the message may simply pass through host gateway application 618, via none 1442. When one of TPDU link client 918, VLP link client 920, and EHEADER 922 receives the message, the link client processes the message in accordance with the communication protocol (block 1304), and hands off the data to length header 910 (block 1306). Length header 910 de-capsulates the data, and forwards the data to one of TPDU session client 902, VLP session client 904, or EHEADER session client 906 in egress 1016 (block 1308). If the message is a pass through, it may be forwarded to none 1440.

The message processed by TPDU session client 902, VLP session client 904, or EHEADER session client 906 is sent via length header 1436 (block 1310) and/or Visa2 forward component 1024, or none 1434 in receive from host method 1422, to host emulator 1012 (block 1312). One of the host emulator components in host emulator 1012 processes the message, and forwards either a result of processing the message to send method 1404. Send method 1404 applies Visa2 framing 1412, adjusts for parity 1410 (block 1314), and either sends the message through length header 1408 or through none 1406, toward the terminal (block 1316).

As described herein, transaction gateway application 616 and host gateway application 618 are part of transaction services data system 300. Transaction services data system 300 may relay messages from/to transaction devices 120 to customer hosts 602 and provide support functions that are related to relaying the messages. Within transaction services data system 300, transaction gateway application 616 and host gateway application 618 identify destinations for received messages, select or set up sessions for efficient delivery of messages, and format and forward messages. Transaction gateway applications 616 may log its activities for reporting purposes and/or for allowing operators/administrators to resolve problems.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While a series of blocks has been described with regard to the processes illustrated in FIGS. 12 and 13, the order of the blocks in the processes may be modified in other implementations. Depending on the implementation, each o the processes may include additional, fewer, different, or differently arranged blocks than those illustrated in FIGS. 12 and 13. Further, non-dependent blocks the processes may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method comprising:
receiving a first message from a transaction device via an intermediate component, the first message requesting an authorization or a settlement of a transaction;
emulating a customer host device based on a first portion of the first message;
generating a second message via the emulation; and
routing the second message via a persistent socket that forms a communication link with the customer host device, the second message requesting a component on the customer host device to authorize the transaction or to settle the transaction.

2. The method of claim 1, wherein receiving the first message from the transaction device includes:
receiving the first message from a dial access server or a transaction web server.

3. The method of claim 1, wherein receiving the first message from the transaction device includes:
creating an instance of a transaction processor to perform the emulating, the generating, and the routing.

4. The method of claim 1, wherein receiving the first message includes:
extracting a header that specifies a length of the first message.

5. The method of claim 1, wherein emulating the customer host device includes:
generating a response based on the first portion of the first message; and
sending the response to the transaction device.

6. The method of claim 5, further comprising at least one of:
stripping a Visa 2 frame from the second message;
modifying a parity of the second message; or
adding, to the second message, a header that indicates a length of the second message.

7. The method of claim 6, further comprising:
sending the second message via one of a transport protocol data unit (TPDU) protocol or a Visa 2 protocol.

8. The method of claim 1, wherein routing the second message includes:
obtaining a destination address of the second message by performing a lookup of the customer host device in a structured query language (SQL) database, a linked list, or a hash table.

9. The method of claim 1, wherein receiving a first message from a transaction device via an intermediate component includes receiving the first message from a transaction device via a dial access server, the method further comprising:
filtering the first message to obtain a transaction information string inserted into the first message via the intermediate component.

10. The method of claim 9, wherein the transaction information string includes:
an automatic number identification; a dialed number identification; or a BAUD rate.

11. The method of claim 9, wherein routing the second message includes:
looking up an Internet Protocol (IP) address of the customer host device based on a bank identification number (BIN) in the first message.

12. The method of claim 9, further comprising:
recreating the persistent socket when the persistent socket becomes unresponsive to a request to forward a message.

13. The method of claim 1, further comprising:
detecting within the first message a pattern of symbols based on a regular expression; or
detecting a Visa 2 frame in the first message.

14. The method of claim 1, wherein routing the second message includes:
forwarding the second message to a host gateway application that includes the persistent socket, wherein the host gateway application is configured to:
maintain the persistent socket communicating with a socket on the customer host device.

15. The method of claim 1, wherein emulating the customer host device includes:
sending an acknowledgment message to the transaction device substantially concurrent to a transmission of a request to connect to the customer host device.

16. A system comprising:
a device including:
an ingress component to:
receive a first message from a terminal, and
filter the first message to obtain a filtered message;
a host emulator to:
receive the filtered message,
emulate a customer host based on the filtered message, and
output a second message via the emulation; and
an egress component to:
send the second message to a host gateway application over a transport control protocol (TCP) communication link.

17. The system of claim 16, further comprising the host gateway application,
wherein the device comprises a blade that is different from a blade on which the host gateway application runs.

18. The system of claim 16, wherein when the ingress component filters the first message, the ingress component is further configured to:
extract a transaction information string that specifies a dialed number identification or a automatic number identification.

19. The system of claim 16, wherein the host emulator is further configured to:
output a reply message as a result of emulating the customer host; and
send the reply message to the terminal.

20. A tangible computer-readable medium comprising computer-executable instructions, when executed by one or more processors, that cause the one or more processors to:
receive a first message from a transaction device, the first message requesting an authorization or a settlement of a transaction;
emulating a customer host device based on a portion of the first message;
generating a second message via the emulation; and
routing the second message via a new socket in a host gateway application,
wherein the host gateway application allocates the new socket to form a communication link with the customer host device, the second message requesting the customer host device to authorize the transaction or to settle the transaction.
